(19) United States
(12) Patent Application Publication
(10) Pub. No.: US 2015/0192172 A1
(43) Pub. Date: Jul. 9, 2015

(54) COAST DOWN BUSHING FOR MAGNETIC BEARING SYSTEMS

(71) Applicants: Martin D. Maier, Allegany, NY (US); H. Allan Kidd, Vero Beach, FL (US)

(72) Inventors: Martin D. Maier, Allegany, NY (US); H. Allan Kidd, Vero Beach, FL (US)

(73) Assignee: DRESSER-RAND COMPANY, Olean, NY (US)

(21) Appl. No.: 14/117,505

(22) PCT Filed: Apr. 3, 2012
(86) PCT No.: PCT/US12/31957

§ 371 Date: Mar. 19, 2015

Related U.S. Application Data
(60) Provisional application No. 61/486,995, filed on May 17, 2011.

(51) Int. Cl. F16C 33/10; F16C 32/04; F16C 33/04; F16C 39/02

(52) U.S. Cl. CPC F16C 33/1095; F16C 39/02; F16C 32/044; F16C 33/046

(57) ABSTRACT

A coast down bushing having a plurality of grooves formed in the inner radial surface thereof. Each groove is filled with a lubricating insert or plug to reduce the contact friction between a rotating shaft and the bushing during coast down or during a rotor shock event or excursion.

This application claims priority to U.S. Patent Application Ser. No. 61/486,995, which was filed May 17, 2011. This priority application is hereby incorporated by reference in its entirety into the present application, to the extent that it is not inconsistent with the present application.

### BACKGROUND

Magnetic bearings are often used to support a rotor using magnetic levitation. The magnetic bearings support the rotor without physical contact, thereby eliminating mechanical wear and exhibiting very low friction. One disadvantage to magnetic bearings, however, is their inability to accommodate high dynamic loads due to their limited load capacity. During peak transient load events, the bearings are unable to control rotor motion that can cause the rotor to contact the bearings and thereby result in significant damage thereto. To account for this, most active magnetic bearing systems employ one or more coast down bushings, also known as auxiliary, backup, secondary, or catcher bearings. Coast down bushings are designed to support the rotor in the event of a total failure of the magnetic bearing system while the machine is slowing down (i.e., coasting down), thereby preventing the rotor from impacting and damaging the adjacent magnetic bearings.

Conventional coast down bushings leave a clearance between the bushing and the rotor, but do not generally rotate. During normal operation, the magnetic bearings support the rotor and hold it within this clearance such that the rotor rarely touches the coast down bushing. When the magnetic bearing system is shut down or fails, however, or during a shock event (e.g., rotor excursion) that exceeds the ability of the bearings to control rotor motion, the rotor is constrained by the coast down bushing. When the rotor impacts the coast down bushing, the rotational motion of the rotor is not always stable and very high stresses and dynamic loads are often endured by the coast down bushing. This is especially true during coast down events where the rotor is required to traverse one or more critical speeds while supported by the bushings. The dynamic loads are greatest and damage to the coast down bushing is most severe when the rotor engages in backward whirl, whereby the rotor orbits the interior of the catcher bearing in a direction opposite to the rotation of the rotor. Also, a large amount of heat is generated from the frictional contact between the rotor and the bushing, which can cause thermal growth and reduction in material strength of the coast down bushings. This damage is cumulative and ultimately results in failure of the bushing. Consequently, coast down bushings require frequent replacement which increases maintenance costs and entails machine downtime.

What is needed, therefore, is a low-friction coast down bushing that reduces the tendency for the rotor to engage in whirl, and especially backward whirl, during a rotor excursion or coast down event and simultaneously reduces detrimental heat generation.

### SUMMARY

Embodiments of the disclosure may provide a coast down bushing. The bushing may include an annular body having inner and outer radial surfaces and an axial length, and grooves defined in the annular body and extending from the inner radial surface to the outer radial surface of the body, each groove spanning across a portion of the axial length and being circumferentially-offset from an adjacent groove. The bushing may further include a lubricating plug disposed within each groove.

Embodiments of the disclosure may further provide a method for reducing contact friction on a rotatable shaft. The method may include arranging a coast down bushing about the rotatable shaft in a non-contact position, the coast down bushing comprising an annular body having an inner radial surface defining one or more grooves, each groove having a lubricating plug disposed therein. The method may further include catching the rotatable shaft with the coast down bushing such that the lubricating plug shears and provides lubrication between the inner radial surface of the annular body and an outer surface of the rotatable shaft.

Embodiments of the disclosure may further provide a rotating machine. The rotating machine may include a housing and a rotatable shaft arranged within the housing, the rotatable shaft having an outer surface, and a coast down bushing coupled to the housing and arranged about the rotatable shaft, the coast down bushing including an annular body having an inner radial surface radially-offset from the outer surface of the rotatable shaft. The rotating machine may further include a groove defined in the inner radial surface of the body, and a lubricating plug disposed within the groove.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1A illustrates an end view of an exemplary coast down bushing, according to one or more embodiments disclosed.

FIG. 1B illustrates a side view of the coast down bushing of FIG. 1A.

FIG. 2 illustrates a perspective view of an arcuate segment of the coast down bushing of FIGS. 1A and 1B.

FIG. 3A illustrates an end view of another exemplary coast down bushing, according to one or more embodiments disclosed.

FIG. 3B illustrates a side view of the coast down bushing of FIG. 3A.

FIG. 4 illustrated is a perspective view of an arcuate segment of the coast down bushing of FIGS. 3A and 3B, according to one or more embodiments described.

FIG. 5A illustrates a partial, cross-sectional, side view of an exemplary coast down bushing, according to one or more embodiments disclosed.

FIG. 5B illustrates a top view of the coast down bushing of FIG. 5A.

FIG. 6 illustrates a flowchart of a method for reducing contact friction on a rotatable shaft of a rotating machine, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

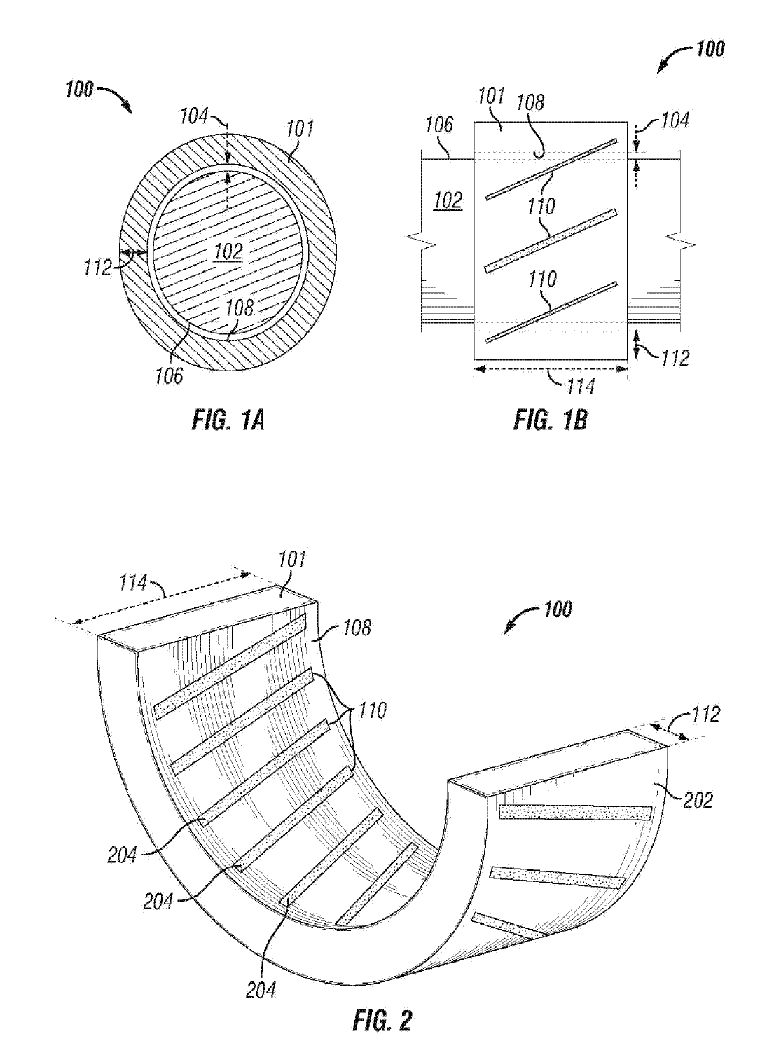

FIGS. 1A and 1B illustrate end and side views, respectively, of an exemplary coast down bushing 100, according to one or more embodiments. The coast down bushing 100, also known as an auxiliary, backup, catcher, or secondary bearing, may be configured to extend circumferentially about a rotatable shaft 102, or rotor. The rotatable shaft 102 may be arranged within various types of rotating machinery (not shown) such as, but not limited to, compressors, pumps, turbines, blowers, fans, expanders, motors, generators, rotary separators, and/or combinations thereof. The shaft 102 may be principally supported at each end by a primary bearing system (not shown), such as an active or passive magnetic bearing system. The bushing 100 may be used as a backup bearing in the event the primary bearing system fails or in the event the shaft 102 absorbs a shock load (e.g., a rotor shock event) that threatens to force the shaft 102 into impacting the primary bearings.

In one embodiment, the bushing 100 may include a generally annular body 101. In other embodiments, however, the body 101 may be of a split construction (see FIGS. 2 and 4) having two or more arcuate segments that may be coupled together to form a complete annulus. The body 101 may be made from a material that exhibits a low frictional coefficient. For example, the base material for the body 101 may be made of a low strength material (relative to the shaft 102) and adapted to reduce heat generation and preclude backward whirl of the shaft 102. The material may also have high thermal conductivity configured to conduct heat away from any contact surfaces of the body 101 in order to prevent localized hot spots which may degrade material properties. In general, copper alloys possess these qualities. In one embodiment, the body 101 may be made of spinodal copper, such as commercially-available TOUGHMET® spinodal copper. In other embodiments, however, the body 101 may be made of a copper-beryllium alloy or any other copper alloy that exhibits a low frictional coefficient.

The bushing 100 may be configured as a stationary component coupled to the inner axial face of a rotating machine housing (not shown). In other embodiments, however, the bushing 100 may be rotatable and disposed within a compliant retainer (not shown) configured to reduce impact load. A material that provides damping, such as a metal mesh, may be disposed within the compliant structure to reduce amplitude while passing through any resonance conditions during deceleration. During operation, the bushing 100 may be radially-offset from the shaft 102, thereby providing a gap 104 that allows the shaft 102 to freely rotate. Specifically, the gap 104 is defined between the outer radial surface 106 of the shaft 102 and the inner radial surface 108 of the body 101. During a rotor excursion, or in the event the primary bearing system fails, the bushing 100 may be configured catch the shaft 102 and impede its radial advancement before impacting any adjacent primary bearings and causing serious damage thereto.

The coast down bushing 100 may also define a plurality of grooves 110 that are circumferentially-offset from each other about the circumference of the body 101 and spanning the majority of its axial length 114, for example. In one embodiment, the grooves 110 may span a smaller portion of the axial length 114 and not the majority thereof. Each groove 110 may be machined into the body 101 and extend through the entire thickness 112 thereof. In at least one embodiment, however, the grooves 110 may originate at the inner radial surface 108 of the body 101 and extend only partially through the thickness 112 thereof. As illustrated, the grooves 110 may be linear and generally parallel to each other. Moreover, the grooves may be slanted or at an angle with respect to the axial ends of the body 101. It will be appreciated by those skilled in the art, however, that the grooves 110 may be divergent and/or slanted at various different angles, including exhibiting no angle of divergence, without departing from the scope of the disclosure. In yet other embodiments, the grooves 110 may be curved.

Referring to FIG. 2, illustrated is a perspective view of an arcuate segment of the coast down bushing 100, according to one or more embodiments described. As illustrated, each groove 110 may extend through the thickness 112 of the body 101 from the inner radial surface 108 to the outer radial surface 202 thereof. Again, other embodiments may include grooves 110 that extend only partially through the thickness 112 of the body 101, but not all the way through to the outer radial surface 202. Moreover, each groove 110 may be filled with or otherwise in-laid with a lubricating plug 204. The lubricating plugs 204 may be lubricious inserts configured to convey a lubricant each time the shaft 102 makes contact with the inner radial surface 108 of the body 101. In one embodiment, the lubricating plugs 204 may be made of an anti-friction material, such as graphite or a graphite alloy. As will be appreciated, however, any similarly lubricious material or substance may be used without departing from the scope of the disclosure.

In operation, the lubricating plugs 204 disposed within the grooves 110 may be configured to simultaneously lubricate the inner radial surface 108 of the body 101 and the outer radial surface 106 of the shaft 102 when contact between the two surfaces 108, 106 is made. As the inner radial surface 108 wears, layers of the lubricious plugs 204 shear off and provide a constant supply of lubrication. The addition of the lubricating plugs 204 provides added and continuous lubrication during coast down ora rotor excursion, without which, galling of the inner radial surface 108 and/or premature seizure of the shaft 102 may result. Moreover, the added lubrication reduces long-term wear on the bushing 100 and also reduces friction heat buildup that would otherwise result in thermal growth of the bushing 100. Consequently, the lubricating plugs 204 increase the lifespan of the bushing 100 and eliminate the need to use a lubricating film or fluid, which could potentially contaminate and/or damage adjacent primary bearings.

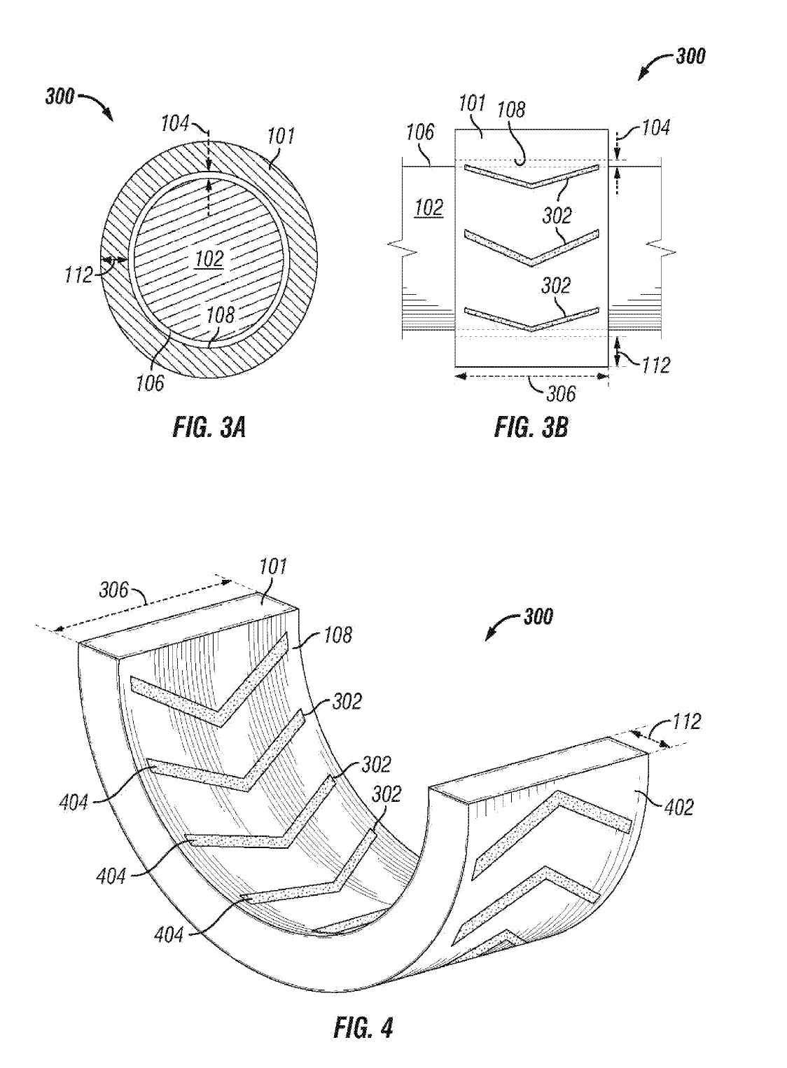

Referring now to FIGS. 3A and 3B, illustrated are end and side views, respectively, of another exemplary coast down bushing 300, according to one or more embodiments. The coast down bushing 300 may be substantially similar in several respects to the coast down bushing 100 described above with reference to FIGS. 1A and 1B. Accordingly, the coast down bushing 300 may be best understood with reference to the coast down bushing 100, where like numerals indicate like elements and therefore will not be described again in detail. The body 101 of the coast down bushing 300 may define a plurality of grooves 302 circumferentially-offset from each other about the circumference of the entire body 101. Similar to the grooves 110 described above, each groove 302 may be machined into the body 101 and extend through the entire thickness 112 thereof. In other embodiments, however, the grooves 302 may originate at the inner radial surface 108 of the body 101 and extend only partially through the thickness 112 thereof.

As illustrated, each groove 302 may be generally “v” shaped and span a majority of the axial length 306 of the body 101, for example. In other embodiments, however, the grooves 302 may be formed in different shapes, designs, and/or sizes, without departing from the scope of the disclosure. For example, in one embodiment, the grooves 302 may span a smaller portion of the axial length 306 and not the majority thereof. In other embodiments, the base of the “v” may be generally rounded so as to resemble a “u” shape in some respects.

Referring to FIG. 4, illustrated is a perspective view of an arcuate segment of the coast down bushing 300, according to one or more embodiments described. As illustrated, each groove 302 may extend through the thickness 112 of the body 101 from the inner radial surface 108 to the outer radial surface 402 thereof. Moreover, similar to the grooves 110 described above, each groove 302 may be filled with or otherwise in-laid with a lubricating plug 404 made of an anti-friction substance, such as graphite or a graphite alloy. The lubricating plugs 404 convey a lubricant each time the inner radial surface 108 of the body 101 and the outer radial surface 106 of the shaft 102 (FIGS. 3A and 3B) come into contact with each other. Upon contact with the shaft 102, layers of lubrication shear off from the lubricating plugs 404 and provide a lubricated engagement.

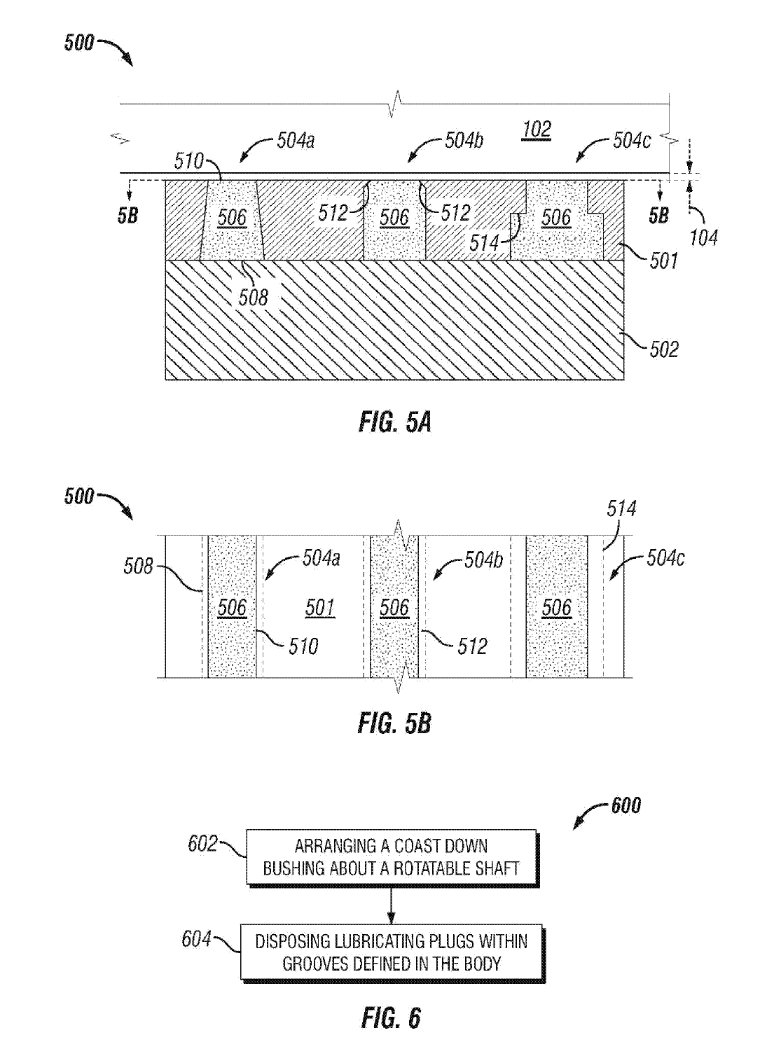

Referring to FIGS. 5A and 5B, illustrated are partial, cross-sectional side (FIG. 5A) and top (FIG. 5B) views of a coast down bushing 500. As indicated, FIG. 5B is taken along the line indicated in FIG. 5A. The coast down bushing 500 may be generally representative of the prior disclosed bushings 100 and 300, as described herein. Accordingly, reference should be made to the descriptions provided above for each bushing 100, 300 to better understand the general characteristics of the coast down bushing 500.

As illustrated, the bushing 500 has a body 501 that is radially offset from the shaft 102, thereby forming a gap 104 therebetween. On its opposite side, for example, the body 501 may be coupled to a rotating machine housing 502. FIG. 5A depicts the longitudinal cross-section of a plurality of exemplary grooves 504 that may be defined in the body 501 and filled with a corresponding lubricating plug 506. It will be appreciated that the grooves 504 and lubricating plugs 506 may be representative of the grooves 110, 302 and the lubricating plugs 204, 404, respectively, described above.

The housing 502 provides a biasing engagement with the bottom of each groove 504a,b,c that is adapted to hold the plug 506 in the corresponding groove 504 from the bottom end. Moreover, each groove 504 may further provide different shapes and/or configurations adapted to retain the lubricating plug 506 within the corresponding groove 504 from the top. For example, the first groove 504a may provide a generally trapezoidal or dove-tail cross-section, where the radius at the bottom 508 is greater than the radius at the top 510 of the first groove 504a. The second groove 504b may provide a generally rectangular cross-section, but may trap or otherwise hold the lubricating plug 506 inside the groove 504b by bending over (i.e., peening) an annular rim 512 of the second groove 504b. The third groove 504c may be define an annular shoulder 514 at an intermediate point whereby the annular shoulder 514 and the biasing engagement with the housing 502 jointly retain the lubricating plug 506 within the groove 504c.

The lubricating plugs 506 may be seated or otherwise received within each groove 504 via a variety of processes. For example, the lubricating plugs 504 may be mechanically pressed into the grooves 504a,b,c from either radial surface. In another embodiment, the body 501 may be heated to expand the opening of each groove 504 and after the lubricating plug 506 is properly inserted therein, the body 501 may be cooled to provide a shrink fit engagement between the lubricating plug 506 and respective groove 504. While only three different shapes and/or configurations of grooves 504 are shown in FIGS. 5A and 5B, it will be appreciated that several other shapes and/or configurations may be employed For example, several different polygonal cross-sectional shapes may be used to retain the plugs 506, without departing from the scope of the disclosure.

Referring now to FIG. 6, illustrated is a flowchart of a method 600 for reducing contact friction on a rotatable shaft of a rotating machine. The method 600 may include arranging a coast down bushing about the rotatable shaft, as at 602. The coast down bushing may include any of the bushings 100, 300, 500 described herein. For example the coast down bushings may include an annular body having an inner radial surface radially-offset from and adjacent an outer surface of the rotatable shaft. The method 600 may also include disposing lubricating plugs within grooves defined in the inner radial surface of the body, as at 604. Each groove may be circumferentially-offset from an adjacent groove about the entirety of the circumference of the body. The lubricating plugs may provide lubrication between the inner radial surface of the annular body and an outer surface of the rotatable shaft when the coast down bushing catches the rotatable shaft during, for example, a coast down event or when a magnetic bearing system is shut down.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A coast down bushing, comprising:
an annular body having inner and outer radial surfaces and an axial length;
grooves defined in the annular body and extending from the inner radial surface to the outer radial surface of the body, each groove spanning across a portion of the axial length and being circumferentially-offset from an adjacent groove; and
a lubricating plug disposed within each groove.

2. The bushing of claim 1, wherein a longitudinal cross-section of at least one of the grooves is dove-tailed.

3. The bushing of claim 1, wherein the annular body comprises two or more arcuate segments that are coupled together.

4. The bushing of claim 1, wherein the annular body comprises a material having a low frictional coefficient.

5. The bushing of claim 4, wherein the material includes spinodal copper.

6. The bushing of claim 4, wherein the material includes a copper alloy.

7. The bushing of claim 1, wherein the grooves are linear and parallel to each other about a circumference of the body.

8. The bushing of claim 7, wherein the grooves are disposed at an angle with respect to axial ends of the body.

9. The bushing of claim 1, wherein the grooves are v-shaped and parallel to each other about a circumference of the body.

10. The bushing of claim 1, wherein the lubricating plug is made of an anti-friction material.

11. The bushing of claim 10, wherein the anti-friction material includes graphite.

12. A method for reducing contact friction on a rotatable shaft, comprising:
arranging a coast down bushing about the rotatable shaft in a non-contact position, the coast down bushing comprising an annular body having an inner radial surface defining a plurality of grooves, each groove spanning across a portion of an axial length of the annular body and being circumferentially-offset from an adiacent groove, and each groove having a lubricating plug disposed therein; and
catching the rotatable shaft with the coast down bushing such that the lubricating plug shears and provides lubrication between the inner radial surface of the annular body and an outer surface of the rotatable shaft.

13. A rotating machine, comprising:
a housing and a rotatable shaft arranged within the housing, the rotatable shaft having an outer surface;
a coast down bushing coupled to the housing and arranged about the rotatable shaft, the coast down bushing comprising an annular body having an inner radial surface radially-offset from the outer surface of the rotatable shaft;
a plurality of grooves defined in the inner radial surface of the body, each groove spanning across a portion of an axial length of the annular body and being circumferentially-offset from an adiacent groove; and
a lubricating plug disposed within the grooves.

14. The rotating machine of claim 13, wherein the body is at least partially made of spinodal copper.

15. The rotating machine of claim 13, wherein the grooves extend from the inner radial surface to an outer radial surface of the body.

16. The rotating machine of claim 13, wherein the grooves are trapezoidal in longitudinal cross-section.

17. The rotating machine of claim 13, wherein a longitudinal cross-section of the grooves is polygonal.

18. The rotating machine of claim 13, wherein the lubricating plug is at least partially made of graphite, a graphite alloy, or a combination thereof.
